(19) United States
(12) Patent Application Publication
(10) Pub. No.: US 2025/0050401 A1
(43) Pub. Date: Feb. 13, 2025

(54) BIPOLAR PLATE, AND METHOD FOR EMBOSSING A CHANNEL STRUCTURE

(71) Applicant: Schaeffler Technologies AG & Co. KG, Herzogenaurach (DE)

(72) Inventors: Sebastian Zwahr, Obermichelbach (DE); Richard BAIER, Aurachtal (DE); Andreas POPP, Nürnberg (DE); Torsten Keller, Heßdorf (DE); Harry SCHMEIKO, Weisendorf (DE); Doris SCHMIDGALL, Langenzenn (DE); Jan KRAEMER, Unterleinleiter (DE)

(21) Appl. No.: 18/718,225

(22) PCT Filed: Nov. 23, 2022
(86) PCT No.: PCT/DE2022/100876

§ 371 Date: Jun. 10, 2024

(30) Foreign Application Priority Data
Dec. 10, 2021 (DE) 102021132658.3

(51) Int. Cl. B21D 13/02; H01M 8/0206; H01M 8/0254; H01M 8/026

(52) U.S. Cl. CPC B21D 13/02; H01M 8/0206; H01M 8/0254; H01M 8/026

(57) ABSTRACT

The invention relates to a method for embossing a channel structure (3) comprising a plurality of parallel channel portions (5) in a planar metal sheet (11) to form a half-plate (2, 2′), in particular for a bipolar plate (1) of an electrochemical cell, said method having the following steps:
providing the planar metal sheet (11) with a uniform initial wall thickness (d5),
inserting the metal sheet (11) into a forming tool (12), wherein a base plane (BE) of the sheet (11) defined by the undeformed planar metal sheet (11) is provided to rest on a tool plane defined by a tool part (13) of the forming tool (12),
forming the plurality of channel portions (5), each channel portion (5) being designed with two non-parallel flanks (7, 8) in such a way as to allow material from embossing portions (9, 10) of the metal sheet (11), which are located outside the flanks and remain in the base plane (BE) and/or a plane parallel thereto throughout the entire forming process, to be displaced into the flanks (7, 8), each flank (7, 8) extending from the base plane (BE) to an adjacent parallel plane.

### CROSS-REFERENCE TO RELATED APPLICATION

The present application is the U.S. National Phase of PCT Patent Application Number PCT/DE2022/100876, filed on Nov. 23, 2022, which claims priority to German Patent Application Number 10 2021 132 658.3, filed Dec. 10, 2021, the entire disclosures of which are incorporated by reference herein.

The disclosure relates to a method for embossing a channel structure comprising a plurality of parallel channel portions in a planar metal sheet to form a half-plate or metal sheet. The disclosure further relates to a bipolar plate of an electrochemical cell, in particular a fuel cell, produced using such a method.

A method for forming a plate-like blank is known, for example, from DE 197 55 964 B4. A product that can be produced using the known forming method has a wall part with reduced thickness. Before forming, the blank from which the product is manufactured is provided with welding paths in regions in which the blank material flows during the forming process, wherein the forming process leads to a reduced wall thickness compared to the wall thickness of the blank, and said welding paths extend in the direction of the material flow that arises during the forming process.

A forming method disclosed in DE 10 2008 031 421 A1 is designed to produce a pot-shaped metallic component from a flat material. This forming method combines deep drawing and pressing and is said to be particularly suitable for producing very complexly shaped components with eccentric portions and regions of low material thickness. In particular, with the help of the forming method according to DE 10 2008 031 421 A1, it should be possible to eliminate a weld seam.

DE 10 2019 103 606 A1 describes a forming method for producing an overpressure predetermined breaking point in a battery cover. Here, material from the battery cover should flow into a forming recess by bringing a stamp part of a forming tool closer to the forming recess in such a way that the remaining distance corresponds to a minimum wall thickness at the overpressure predetermined breaking point.

DE 10 2013 103 612 A1 discloses a compression tool which is intended for the production of highly dimensionally stable half-shells. When forming the half-shells, side walls of a tool are moved perpendicular to the direction of movement of a stamp. Thus, during forming, a plurality of tool components perform adjustment movements in mutually orthogonal directions.

Various forming methods in which sheet metal is formed under the influence of temperature are described, for example, in documents EP 3 485 992 B1, EP 0 946 311 B1 and DE 195 29 429 C2.

Documents EP 2 292 343 A1 and DE 10 2007 013 017 B4 disclose various devices for electrohydraulic or electromagnetic sheet metal forming.

US 2016/158 821 A1 describes a press-forming method with which a flat metal sheet is formed by press-forming. A shear deformation step is carried out in which material flows towards a curved portion.

DE 10 2010 044 788 A1 discloses a forming tool and a method for producing a deep-drawn sheet metal part. In addition to deep drawing, a second manufacturing step is carried out, in particular in the form of extrusion.

DE 10 2017 124 724 A1 describes a method for the continuous production of a vehicle component from a metal sheet. For this purpose, the metal sheet is heated before the metal sheet is separated and/or formed.

The object of the disclosure is that of specifying sheet metal forming options which have been further developed with respect to the prior art mentioned and which allow wall thickness variations within the end product, with particular suitability for the production of channel structures of bipolar plates of electrochemical cells, in particular fuel cells.

This object is achieved according to the disclosure by a method for embossing a channel structure comprising the steps according to claim 1. The embossing method according to claim 1 is particularly suitable for producing at least one metal sheet or half-plate for a bipolar plate according to claim 7. The embodiments and advantages of the disclosure explained below in connection with the device, that is to say the bipolar plate or a bipolar plate component, in particular in the form of a half-plate, which is part of a bipolar plate, also apply, mutatis mutandis, to the embossing method, that is to say forming method, and vice versa.

The method for embossing a channel structure comprising a plurality of parallel channel portions in a planar metal sheet to form a half-plate or metal sheet, in particular for a bipolar plate, comprises the following steps:
providing the planar metal sheet with a uniform initial wall thickness,
inserting the metal sheet into a forming tool, wherein a base plane of the metal sheet defined by the undeformed planar metal sheet is provided to rest on a tool plane defined by a tool part of the forming tool,
forming the plurality of channel portions, wherein each channel portion is formed with two mutually non-parallel flanks in such a way that material of embossing portions of the metal sheet which are located outside the flanks and remain during the entire forming process in the base plane and/or a plane parallel thereto is displaced into the flanks, wherein each flank extends from the base plane to an adjacent parallel plane.

The disclosure is based on the idea that, during the deep drawing of sheet metal, the flat structure of the starting product, i.e., initially planar metal sheet, is basically retained, with the wall thickness of the metal sheet in different sheet metal portions either remaining unchanged or being reduced by the forming.

A reduction in wall thickness occurs during deep drawing, in particular in regions in which material is displaced from a base plane in which the metal sheet used as the starting product originally lies, in order to produce wall portions that are inclined relative to the base plane, in extreme cases wall portions that run perpendicular to the base plane. Provided that portions of the starting product that are located outside the inclined portions remain in an unchanged position throughout the entire forming process, only the material that was originally in a surface portion is available for forming the inclined portions, with said surface portion corresponding to the perpendicular projection of the inclined portion with respect to the base plane.

This means that the more pronounced the inclination of the corresponding portions of the end product which protrude from the base plane, the less material is available for forming any materials using deep drawing. It should also be borne in mind that high degrees of forming, depending on the material used, can lead to work hardening and increase the tendency of the product to crack. These risks can be countered in conventional methods by avoiding steep flanks of embossed structures, although in cases where the embossed structures limit channels for liquid and/or gaseous fluids, this can mean compromising the fluidic optimum.

The embossing method according to the application efficiently addresses this conflict of objectives between forming and fluidic aspects in that material flows to a significant extent in the plane in which the metal sheet lies between regions of different inclinations, in each case in relation to the base plane as a reference plane. Compared to conventional deep-drawing methods, the embossing method is enriched with features of extrusion. The portions from which material flows into the flanks, i.e., the embossing portions, remain in their original position during the embossing process. This means that entire portions are not drawn into the flanks during forming.

In particular, an embossing portion can be located in the base plane. Likewise, embossing portions can exist which each constitute a bottom of a channel portion. Material from at least one embossing portion which is located outside the channel portions and lies in the base plane is preferably forced into at least one of the flanks adjacent to it. Furthermore, material from at least one embossing portion in a plane parallel to the base plane, which constitutes the bottom of a channel portion which is located between two flanks and is parallel to the base plane, is preferably displaced into one of the flanks adjacent thereto. The channel portion, the flanks of which are reinforced with material from the base plane and/or a plane parallel thereto, can in particular have a cross section with a trapezoidal basic shape. The flanks of the channel portion are inclined relative to the base plane, for example, by an angle of at least 45° and at most 78°, although there is not necessarily same angle of inclination with both flanks. Embodiments with a completely or partially arcuate shape, for example a circular arc shape or elliptical shape, of the flanks can also be realized. Likewise, a completely planar shape of the channel bottom formed between the flanks is not required. It is also possible to eliminate an extensive channel bottom, in which case the channel can in particular have a U-shape or a V-shape.

By forming the originally planar metal sheet, its wall thickness can be reduced, for example to a minimum of 70% of the initial wall thickness, according to various possible variants of the method. Other values that affect the material distribution arise whenever the projection is considered in relation to the base plane. In this regard, there may be an accumulation of material in the region of the flanks, which can be expressed as a projected wall thickness of 105% to 150% of the initial wall thickness.

In cases where a particularly large amount of material is displaced by embossing planar regions, the flow of material from the planar metal sheet used as the starting product into the flanks of the channel structure can even be so pronounced that the maximum wall thickness of the end product is not in a planar region, but can be found in the region of the flanks.

The embossing of planar regions, which is practiced to accumulate material in flank regions, results in a wall thickness in the embossed regions which is, for example, between 50% and 95%, in particular between 60% and 90%, of the initial wall thickness of the metal sheet. Embossing also has the advantage that even when using metal sheets with significant fluctuations in wall thickness caused by quality fluctuations within one and the same metal sheet, an end product with comparatively narrow tolerances in terms of wall thicknesses in different surface sections can be produced.

The embossing depth of the channel structure produced by sheet metal forming is, for example, twice and up to ten times the initial wall thickness of the metal sheet. If all planar regions of the metal sheet are processed in the same way as embossing portions, a uniform wall thickness of the end product can theoretically be achieved. If, on the other hand, the forming process results in a wall thickness that varies from surface portion to surface portion, wherein the portions mentioned can in particular have a linear shape in plan view of the structured plate, that is to say the formed metal sheet, then the minimum wall thickness of the half-plate is, for example, no less than ⅔ of the maximum wall thickness of the half-plate of the end product. The minimum wall thickness of the half-plate can be in particular in planar regions outside the flanks of the channel structure, namely in embossed regions. The maximum wall thickness can also be present in a planar region of the structured half-plate, but alternatively—as already stated—in the flank region of the half-plate.

The forming method can be carried out with an already coated metal sheet as well as with an uncoated metal sheet. The metal sheet is in particular a steel sheet. The formed metal sheet provided with the channel structure can be used in particular for a bipolar plate in a fuel cell system or in an electrolysis system for producing hydrogen. The bipolar plate can comprise at least one metal sheet embossed according to the disclosure. In particular, however, the bipolar plate comprises two metal sheets embossed according to the disclosure, one for an anode side and one for a cathode side of the bipolar plate. The two embossed half-plates are usually connected to one another by welding to form a bipolar plate.

In the following, an exemplary embodiment of the disclosure is explained in more detail with reference to drawings. Here in simplified form and partly in exaggerated form:

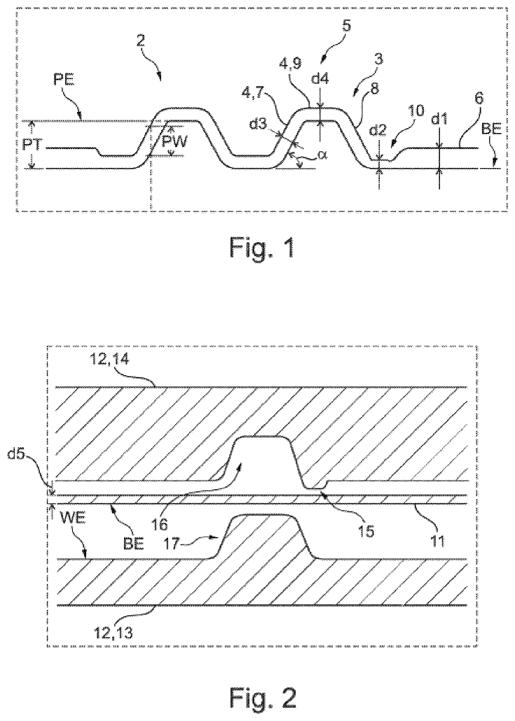

FIG. 1 shows an embossed structure of a metal sheet or half-plate;

FIG. 2 shows features of a tool for embossing the metal sheet or half-plate;

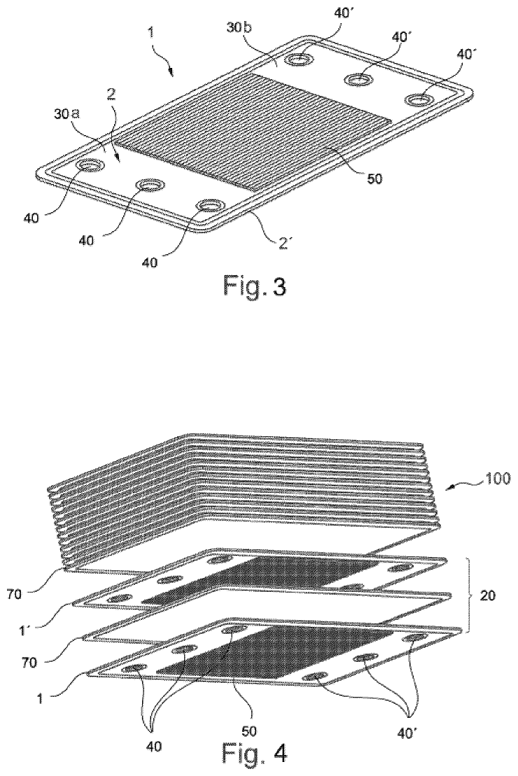

FIG. 3 shows a bipolar plate;

FIG. 4 shows a fuel cell system comprising a plurality of fuel cells.

FIG. 1 shows a half-plate 2 marked with the reference sign 2. Two such half-plates 2, 2′ can be connected to one another, for example by welding, to form a bipolar plate 1 (see FIG. 3). Within a fuel cell system 100 (see FIG. 4), a bipolar plate 1 separates a half-cell of a first fuel cell from a half-cell of a further fuel cell. With respect to the basic function of a bipolar plate 1, reference is made to the prior art cited at the outset.

The half-plate 2 has an embossed structure 3, which in the present case is a channel structure comprising a plurality of parallel channel portions 5, which lies in an active field of the later fuel cell system 100. Channels for fluids flowing through the fuel cell system 100 can be formed between two half-plates 2, 2′ lying one on top of the other and on the outer surfaces of the bipolar plate 1. The fluids are coolants and operating materials of the fuel cell system 100.

A channel portion 5 which is formed by the embossed structure 3 has a wall denoted overall by 4. The wall 4 is composed of two flanks 7, 8 and a bottom 9. The planar main region of the half-plate 2, which is denoted by 6 and which lies in a base plane BE, is located outside the channel portion 5. The wall thickness of the planar main region 6 is denoted by d1, unless it is specifically reduced, which is discussed in more detail below.

The channel portion 5 has a trapezoidal cross-sectional shape, the angle of inclination of the flanks 7, 8 relative to the main region 6 and thus also relative to the base plane BE being indicated by a. Deviating from the exemplary embodiment outlined, the various flanks 7, 8 could also be inclined to different degrees relative to the base plane BE. In any case, the bottom 9 is located here in an embossing plane PE that is parallel to the base plane BE. The distance between the base plane BE and the embossing plane PE constitutes the embossing depth, denoted by PT, of the embossed structure 3.

When forming the embossed structure 3, an undeformed planar metal sheet metal 11 is started with, which is inserted into a forming tool 12. A tool lower part of the forming tool 12 is denoted by 13, and a tool upper part is denoted by 14. The tool lower part 13 provides a tool plane WE on which the base plane BE of the half-plate 2 to be formed from the metal sheet 11 comes to rest. The basic shape of the embossed structure 3 of the half-plate 2 is predetermined by the cross-sectional shape of the tool parts 13, 14, which have tool contours 16, 17 for this purpose.

Furthermore, in the example shown in FIG. 2, an embossed contour 15 of the tool upper part 14 can be seen, which is located directly next to the portion in which the channel structure 3 is to be created. The embossed contour 15 ensures that a reduced wall thickness d2 is produced in the corresponding region of the half-plate 2, referred to as the embossing portion 10, and thus material is displaced. The reduced wall thickness d2 is the minimum wall thickness created by forming. The displacement of the material means that material flows in the transverse direction of the half-plate 2 and thus in particular into the flanks 7, 8. This results in a wall thickness d3 in the region of the flanks 7, 8, which wall thickness is greater than an imaginary wall thickness that would arise without the embossing process. PW denotes the projected wall thickness of the flanks 7, 8, which refers to a projection with respect to the base plane BE.

In addition, in the present case, embossing also takes place in the region of the bottom 9, which means that material from the bottom 9, which here constitutes an embossing portion, flows into the flanks 7, 8. The wall thickness of the bottom 9 is indicated as d4. The material flow that takes place during forming, both from the main region 6 and from the bottom 9 into the flanks 7, 8, ensures that the cavity formed between the tool contours 16, 17 within the closed forming tool 12 is completely filled.

Material flows not only into curved regions that adjoin the planar regions, but also into the entire length of the flanks 7, 8 formed. The initial wall thickness, denoted by d5, of the undeformed metal sheet 11 is in the range from 50 μm to 100 μm in the exemplary embodiment.

FIG. 3 shows a bipolar plate 1 comprising two half-plates 2, 2′ made of stainless steel, which are formed by the method according to the disclosure and connected to one another by welding. The bipolar plate 1 has an inflow region 30a for fluids with openings 40 and an outflow region 30b for the fluids with openings 40′. A gas distribution structure 50 with channel structures 3 is arranged in between and comprises channel portions 5 (cf. FIG. 1).

FIG. 4 shows a fuel cell system 100 comprising a plurality of fuel cells 20 as an example of an electrochemical cell. The same reference signs as in FIG. 3 indicate identical elements. A fuel cell 20 comprises two bipolar plates 1, 1′ with a polymer electrolyte membrane 70 or membrane electrode unit (MEA) which is arranged between them and which is usually covered on both sides with a gas diffusion layer.

### LIST OF REFERENCE SIGNS

1, 1′ Bipolar plate
2, 2° Half-plate
3 Embossed structure, channel structure
4 Wall
5 Channel portion
6 Planar main region
7 Flank
8 Flank
9 Bottom
10 Embossing portion
11 Undeformed metal sheet
12 Forming tool
13 Tool lower part
14 Tool upper part
15 Embossed contour
16 Tool contour of the tool upper part
17 Tool contour of the tool lower part
20 Fuel cell
30a Inflow region
30b Outlet region
40, 40′ Opening
50 Gas distribution structure
70 Polymer electrolyte membrane
100 Fuel cell system
α Angle
BE Base plane
d1, d2, d3, d4, d5 Wall thickness
PE Embossing plane
PT Embossing depth
PW Projected wall thickness
WE Tool plane

1. A method for embossing a channel structure comprising a plurality of parallel channel portions in a planar metal sheet to form a half-plate, having the following steps:
providing the planar metal sheet with a uniform initial wall thickness,
inserting the metal sheet into a forming tool, wherein a base plane of the sheet defined by the undeformed planar metal sheet is provided to rest on a tool plane defined by a tool part of the forming tool,
forming the plurality of channel portions, wherein each channel portion is formed with two mutually non-parallel flanks in such a way that material of embossing portions of the metal sheet which are located outside the flanks and remain during the entire forming process in the base plane and/or a plane parallel thereto is displaced into the flanks, wherein each flank extends from the base plane to an adjacent parallel plane.

2. The method according to claim 1, wherein material of at least one embossing portion which is located outside the channel portions and lies in the base plane is forced into at least one of the adjacent flanks.

3. The method according to claim 1, wherein material of at least one embossing portion in a plane which is parallel to the base plane and which constitutes the bottom of a channel portion that is located between two flanks and is parallel to the base plane is displaced into one of the flanks adjacent thereto.

4. The method according to claim 1, wherein, as a result of the forming, the wall thickness of the flanks is reduced to no less than 70% of the initial wall thickness.

5. The method according to claim 1, wherein, as a result of the forced flow of material into the flanks, the projected wall thickness of the flanks to be measured in the normal direction of the base plane is increased to at least 105% and at most 150% of the initial wall thickness.

6. The method according to claim 1, wherein an embossing depth of the channel structure is chosen to be at least twice and at most ten times the initial wall thickness of the metal sheet.

7. A bipolar plate of an electrochemical cell, comprising at least one half-plate with a channel structure produced in the method according to claim 1 for a medium flowing through the electrochemical cell.

8. The bipolar plate according to claim 7, wherein the half-plate has a minimum wall thickness which is no less than ⅔ of a maximum wall thickness of the half-plate.

9. The bipolar plate according to claim 8, wherein the minimum wall thickness is defined outside the flanks of the channel structure.

10. The bipolar plate according to claim 9, wherein the maximum wall thickness is defined in the region of the flanks of the channel structure.

11. A method of embossing a channel structure of a half-plate of a bipolar plate comprising:
providing an undeformed planar metal sheet with a uniform initial wall thickness;
inserting the undeformed planar metal sheet into a forming tool to form the half-plate including a base plane, wherein the base plane of the half-plate is situated on a tool plane of the forming tool; and
forming a plurality of channel portions of the channel structure of the half-plate, wherein each channel portion is formed with two mutually non-parallel flanks such that material of embossing portions of the planar metal sheet are located outside the flanks and remain during the entire forming process in the base plane.

12. The method according to claim 1, wherein a plane parallel to the base plane is displaced into the flanks, wherein each flank extends from the base plane to an adjacent parallel plane.

13. The method according to claim 1, wherein the material of at least one embossing portion is forced into at least one of the adjacent flanks, wherein the embossing portion is located outside the channel portions and lies in the base plane.

14. The method according to claim 1, wherein material of at least one embossing portion in a plane parallel to the base plane and constitutes the bottom of a channel portion located between two flanks and is parallel to the base plane is displaced into one of the flanks.

15. The method according to claim 1, the wall thickness of the flanks is reduced to no less than 70% of the initial wall thickness.

16. The method according to claim 1, wherein the projected wall thickness of the flanks, measured in the normal direction of the base plane, is increased to between 105% and 150% of the initial wall thickness.

17. The method according to claim 1, wherein an embossing depth of the channel structure is between two and ten times the initial wall thickness of the metal sheet.

18. An electrochemical cell comprising:
a bipolar plate including a pair of half-plates,
wherein the bipolar plate includes an inflow region and an outflow region,
wherein at least one half-plate includes a gas distribution structure including a channel structure, wherein the channel structure includes a plurality of channel portions, wherein each channel portion is formed with two mutually non-parallel flanks such that material of embossing portions of a planar metal sheet of the at least one half-plate are located outside the flanks and remain in a base plate of the half-plate during a forming process of the channel structure.

19. The electrochemical cell according to claim 18, wherein the at least one half-plate has a minimum wall thickness no less than ⅔ of a maximum wall thickness of the at least one half-plate.

20. The electrochemical cell according to claim 18, wherein the minimum wall thickness is defined outside the flanks of the channel structure and the maximum wall thickness is defined in the region of the flanks of the channel structure.
